(19) United States
(12) Patent Application Publication
(10) Pub. No.: US 2026/0199721 A1
(43) Pub. Date: Jul. 16, 2026

(54) AUTOMATIC FIRE EXTINGUISHER SPECIALLY DESIGNED FOR ELECTRIC BICYCLES

(71) Applicant: Chenzhou Lianxiang Planning Co., Ltd, Chenzhou (CN)

(72) Inventors: Yuanlong Huang, Chenzhou (CN); Yi Huang, Chenzhou (CN); Keming Huang, Chenzhou (CN); Kewei Huang, Chenzhou (CN)

(21) Appl. No.: 19/057,154

(22) Filed: Feb. 19, 2025

(30) Foreign Application Priority Data
Jan. 10, 2025 (CN) 202520053325X

(51) Int. Cl. A62C 3/16; A62C 3/07; A62D 1/00

(52) U.S. Cl. CPC A62C 3/16; A62C 3/07; A62D 1/0014

(57) ABSTRACT

An automatic fire extinguisher specially designed for electric bicycles, comprising a fire extinguisher bottle, and a fire extinguishing agent in the fire extinguisher bottle; the fire extinguishing agent adopts ammonium phosphate dry powder, and a sealing plate is fixedly arranged at a nozzle opening of the fire extinguisher bottle; the sealing plate melts after being heated to a set temperature, and the fire extinguishing agent is sprayed out from the fire extinguisher bottle through the nozzle. The invention has the following advantages: it has a small size and can be carried on an electric bicycle; in the event of a fire, it can automatically activate and extinguish the fire, ensuring the safety of people and property; its structure is simple, facilitating mass production and manufacturing with lower production costs, making it suitable for widespread application and promotion.

### TECHNICAL FIELD

The invention relates to the field of fire protection, and in particular to an automatic fire extinguisher specially designed for electric bicycles.

### BACKGROUND ART

Currently, for the convenience of travel, an increasing number of people choose to commute by electric bicycles. These bicycles mostly use lead-acid batteries or lithium batteries as their power source, which are installed on the bicycles in the form of battery packs. While this method offers convenience, it lacks sufficient safety measures. If an electric bicycle catches fire while charging or if the battery shorts out for any reason, the energy within the battery can be released in the form of heat in a short period of time. This can ignite the internal components of lithium batteries or cause the battery pack to rupture, leading to electrolyte leakage, which may subsequently trigger combustion or even explosion of the lithium batteries in the vehicle, posing a threat to personal and property safety. Therefore, it is crucial to promptly detect dangerous situations once a battery catches fire and extinguish the fire as quickly as possible to ensure the safety of people and property.

In order to solve the above problems, there is an urgent need for an automatic fire extinguisher specially designed for electric bicycles to extinguish fires that occur when electric bicycles are charging or parked.

### SUMMARY OF THE INVENTION

The technical problem to be solved by the invention is to overcome the defects of the above technology and provide an automatic fire extinguisher specially designed for electric bicycles.

To solve the above technical problems, the technical scheme provided by the invention is as follows: an automatic fire extinguisher specially designed for electric bicycles, comprising a fire extinguisher bottle, and a fire extinguishing agent in the fire extinguisher bottle; the fire extinguishing agent adopts ammonium phosphate dry powder, and a sealing plate is fixedly arranged at a nozzle opening of the fire extinguisher bottle; the sealing plate melts after being heated to a set temperature, and the fire extinguishing agent is sprayed out from the fire extinguisher bottle through the nozzle.

Further, the sealing plate is made of a tin-bismuth alloy plate, wherein tin is 52% and bismuth is 48%.

Further, an outlet valve is installed at a mouth of the fire extinguisher bottle.

Further, a handle is arranged on a top of the fire extinguisher bottle.

Compared with the prior art, the invention has the following advantages:

1. it has a small size and can be carried on an electric bicycle;

2. in the event of a fire, it can automatically activate and extinguish the fire, ensuring the safety of people and property;

3. its structure is simple, facilitating mass production and manufacturing with lower production costs, making it suitable for widespread application and promotion.

### BRIEF DESCRIPTION OF ACCOMPANYING DRAWINGS

FIG. 1 is a schematic diagram 1 of the structure of an automatic fire extinguisher specially designed for electric bicycles of the invention.

FIG. 2 is a schematic diagram 2 of the structure of the automatic fire extinguisher specially designed for electric bicycles of the invention.

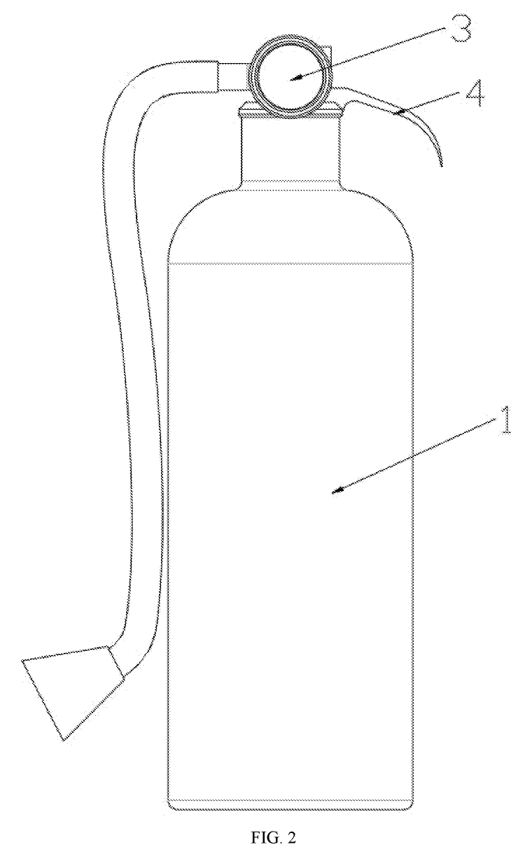

As shown in the figures:

1) Fire extinguisher, 2) Sealing plate, 3) Outlet valve, and 4) Handle

### SPECIFIC EMBODIMENT OF THE INVENTION

In order to make the objects, technical schemes and advantages of the embodiments of the invention clearer, the technical schemes in the embodiments of the invention will be clearly and completely described below in combination with the accompanying drawings in the embodiments of the invention, obviously, the described embodiments are some, but not all embodiments of the invention. The components of the embodiments of the invention generally described and illustrated in the drawings herein may be arranged and designed in a variety of different configurations.

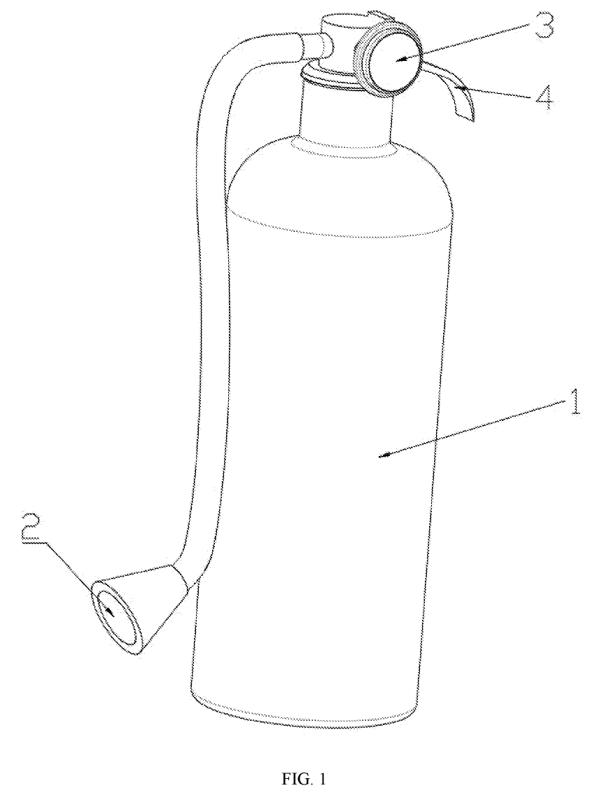

Embodiment 1, in combination with FIG. 1- 2, an automatic fire extinguisher specially designed for electric bicycles, comprising a fire extinguisher bottle 1, and a fire extinguishing agent in the fire extinguisher bottle 1; the fire extinguishing agent adopts ammonium phosphate dry powder, and a sealing plate 2 is fixedly arranged at a nozzle opening of the fire extinguisher bottle 1; the sealing plate 2 melts after being heated to a set temperature, and the fire extinguishing agent is sprayed out from the fire extinguisher bottle 1 through the nozzle.

In the specific implementation of the invention, during the electric vehicle charging process, the charger is placed in front and below the nozzle of the fire extinguisher. If the charger catches fire during charging, the temperature around the fire extinguisher will rapidly rise. The high-temperature smoke will increase the temperature of the sealing plate 2. When the temperature reaches a certain level, the sealing plate 2 will melt, and the fire extinguishing agent sprayed from the nozzle of the fire extinguisher bottle 1 will form a fire barrier, preventing the spread of the fire and avoiding the occurrence of major accidents.

In this specific embodiment, the sealing plate 2 is made of a tin-bismuth alloy plate, wherein tin is 52% and bismuth is 48%; the sealing plate 2 is 2mm thick and is glued to the nozzle with epoxy resin glue. When the temperature rises to above 138°C, the sealing plate 2 melts.

In this specific embodiment, the capacity of the fire extinguisher bottle 1 is not less than 1kg.

In this specific embodiment, an outlet valve 3 is installed at a mouth of the fire extinguisher bottle 1, facilitating the production, transportation, and storage of the automatic fire extinguisher specially designed for electric bicycles with high safety. After installing the fire extinguisher bottle 1 on the electric bicycle, the outlet valve 3 can be switched to a normally open state.

In this specific embodiment, a handle 4 is arranged on a top of the fire extinguisher bottle 1, making it convenient to lift and move.

In the description of the invention, it should be understood that the orientation or positional relationship indicated by the terms “center”, “upper”, “lower”, “left”, “right”, “vertical”, “horizontal”, “inner”, “outer” and so on are based on the orientation or positional relationship shown in the accompanying drawings, or the orientation or positional relationship that product of the invention is usually placed in when it is used, only for the convenience of describing the invention and simplifying the description, rather than indicating or implying that the indicated device or element must have a specific orientation, as well as a specific orientation structure and operation, therefore, it should not be construed as a limitation of the invention. In addition, the terms of “first”, “second”, “third” and so on are only used to differentiate the description, and should not be construed as indicating or implying relative importance.

In addition, if the terms “horizontal”, “vertical”, “overhanging” and other terms appear, it does not mean that the component is required to be absolutely horizontal or overhanging, but can be slightly inclined. For example, “horizontal” simply means that its direction is more horizontal than “vertical”, it does not mean that the structure must be completely horizontal, but can be slightly inclined.

In the description of the invention, “a plurality of” means at least two.

In the description of the invention, it should also be noted that the terms of “arrange”, “install”, “link”, “connect”, etc., should be generally understood unless there are specific restrictions or stipulations, for example, the “connect” may refer to fixed connection, detachable connection or integral connection; the “connect” may also refer to mechanical connection or electrical connection; the means of “connect” may be directly connected or indirectly connected through an intermediate medium, and may be internal communication between the two elements. For those skilled in the art, the specific meaning of the above terms in the invention can be understood according to the specific situation.

The invention and its embodiments are described above, this description is not restrictive, and what is shown in the accompanying drawing is only one of the embodiments of the invention, and the actual structure is not limited to this. All in all, if those skilled in the art receives its enlightenment, without deviating from the object of the invention, and without creatively designing structures and embodiments similar to the technical scheme of the invention shall fall within the protection scope of the invention.

1. An automatic fire extinguisher specially designed for electric bicycles, comprising a fire extinguisher bottle, and a fire extinguishing agent in the fire extinguisher bottle;
the fire extinguishing agent adopts ammonium phosphate dry powder, and a sealing plate is fixedly arranged at a nozzle opening of the fire extinguisher bottle;
the sealing plate melts after being heated to a set temperature, and the fire extinguishing agent is sprayed out from the fire extinguisher bottle through the nozzle.

2. The automatic fire extinguisher specially designed for electric bicycles of claim 1, wherein the sealing plate is made of a tin-bismuth alloy plate, tin is 52% and bismuth is 48%.

3. The automatic fire extinguisher specially designed for electric bicycles of claim 1, wherein the sealing plate is 2mm thick.

4. The automatic fire extinguisher specially designed for electric bicycles of claim 1, wherein the capacity of the fire extinguisher bottle is not less than 1kg.

5. The automatic fire extinguisher specially designed for electric bicycles of claim 1, wherein
an outlet valve is installed at a mouth of the fire extinguisher bottle.

6. The automatic fire extinguisher specially designed for electric bicycles of claim 1, wherein a handle is arranged on a top of the fire extinguisher bottle.
